(19) United States
(12) Patent Application Publication
(10) Pub. No.: US 2010/0050708 A1
(43) Pub. Date: Mar. 4, 2010

(54) Tamperproof power tailgate lock

(76) Inventor: Dimiter S. Zogoroff, Lincoln, MA (US)

Correspondence Address: Dimiter S. Zagoroff, 55 Winter Street, Lincoln, MA, 01773, US

(21) Appl. No.: 12/583,964

(22) Filed: Aug. 27, 2009

Related U.S. Application Data
(60) Provisional application No. 61/092,221, filed on Aug. 27, 2008.

(51) Int. Cl. E05B 65/06

(52) U.S. Cl. 70/101

(57) ABSTRACT

A tamperproof power lock is provided for use in a pickup truck tailgate latch handle. The lock includes a power actuator, a rotating crank, a connecting rod and a lock bolt that locks the tailgate handle. The linear output motion of the actuator is transferred into rotation of the crank that is limited to rotate between two stops. An over center spring or friction keeps the crank or the lock bolt in either of the two stop positions. The rotation of the crank is transferred into linear motion of the locking bolt by the connecting rod. In the locked position the crank is up against one of the stops and the connecting rod past dead center. As a result the locking bolt cannot be pushed back forcibly in an attempt to defeat the lock.

### RELATED APPLICATION

This application claims the benefit of U.S. Provisional Application No. 61/092,221, filed on Aug. 27, 2008 the entire teachings of that are incorporated herein by reference

### FIELD OF INVENTION

This invention relates to electrically powered locks. Specifically, it relates to a power lock for the tailgate of a pick up truck.

### BACKGROUND OF THE INVENTION

Heretofore electrical actuators employed in locking the tailgate of trucks have been mounted in such a manner, that the linear motion of the internal rack and pinion mechanism is directly coupled to the sliding motion of the locking bolt. The locking bolt can be easily pushed back by hand once the power to the actuator is switched off since the pinion of the motor offers little resistance to movement of the rack.

As a result, one limitation of existing power locks is that they can be defeated easily by reaching through the gap between the plastic trim piece and the tailgate handle and pushing the locking bolt out of the way by hand or using a tool such as a common screw driver.

The need exists, therefore, for a tamper proof power lock

### SUMMARY OF THE INVENTION

The present invention comprises a power actuator, a rotating crank, a connecting rod and a locking bolt. The linear output motion of the actuator is transferred into rotation of the crank that is limited to rotate between two stops. An over center spring biases the crank in either of the two end positions. The rotation of the crank is transferred into linear motion of the locking bolt by the connecting rod. In the locked or fully extended position the crank is up against one of the stops just past its dead center. As a result the locking bolt cannot be pushed back forcibly in an attempt to defeat the lock.

The primary object and advantage of my invention is to provide a power lock with a locking lock bolt that can be moved to and fro by an internal linear actuator but not by any external forces when it is in the extended position.

A further object and advantage of my invention is to provide a tamperproof power lock that cannot be reset from the outside.

Still further objects and advantages will become apparent from a consideration of the ensuing description and accompanying drawings.

### BRIEF DESCRIPTION OF THE DRAWING

FIG. 1A is an overall perspective view of a preferred embodiment prior to installation with the cover removed for clarity.

FIG. 1B shows the preferred embodiment in the same perspective but in an exploded view to illustrate the various elements.

FIG. 2 is an overall perspective view of the preferred embodiment installed on the handle mechanism with the cover raised for clarity.

FIGS. 3 A-B is a plan view of the preferred embodiment in the “locked” and “unlocked” positions respectively with the cover removed for clarity.

### DESCRIPTION OF THE INVENTION

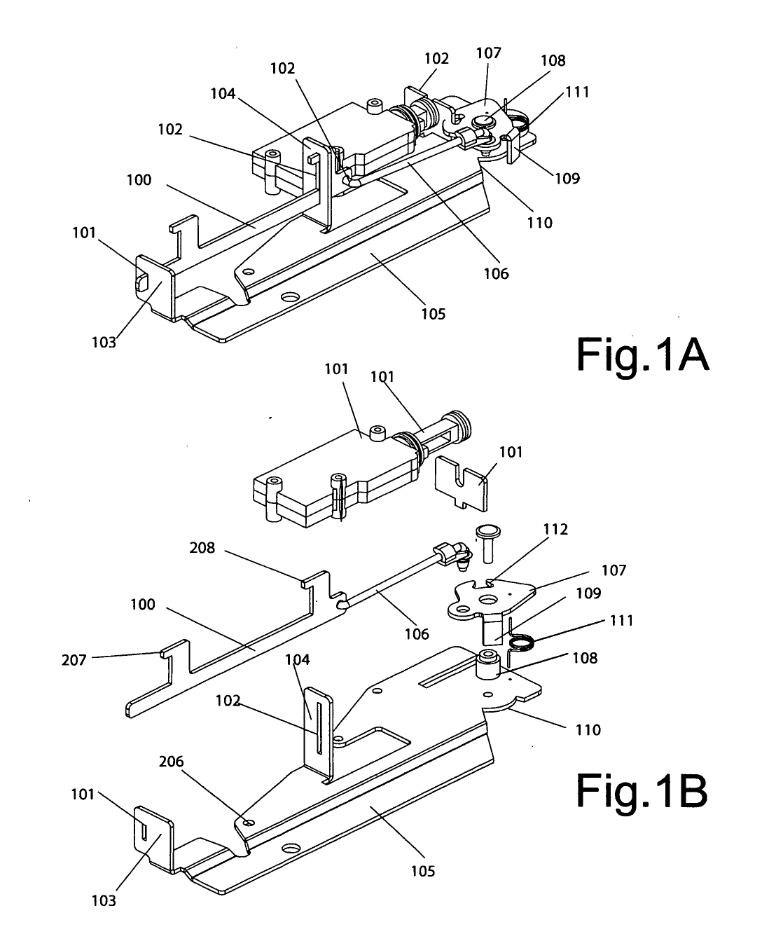

Referring to FIGS. 1A and 1B, one embodiment of the present invention comprises a locking bolt 100 which is mounted movably in slots 101 and 102 on the flanges 103 and 104 of a bracket 105. The position of the locking bolt 100 is controlled by the connecting rod 106 which attaches to the locking bolt 100 at one end and to a crank 107 at the other end. Crank 107 pivots on a post 108 in bracket 105 and carries a pawl 109 which rotates inside a sector 110 of the bracket 105. The sector 110 limits the angle of rotation of the crank 107. A spring 111 is mounted between the bracket 105 and the crank 107 in such a fashion that it biases the crank 107 either to one or the other end positions of the sector 110. The crank 107 can also be retained in place by the friction, for example by a wave washer (not shown) instead of spring loading, The linear power actuator 115 has to be strong enough to overcome either the friction or the spring loading. The crank 107 has a slot 112 which engages a rack driver 113 attached to the output rod 114 of a linear power actuator 115 that is mounted on the bracket 105. The rack driver 113 and slot 112 function in the fashion of a “rack and pinion” to convert the linear motion of the output rod 114 into rotation of the crank, however the slot 112 may be sized to permit enough lost motion to allow the output rod 114 to return to a neutral position when the linear power actuator 115 is de-energized.

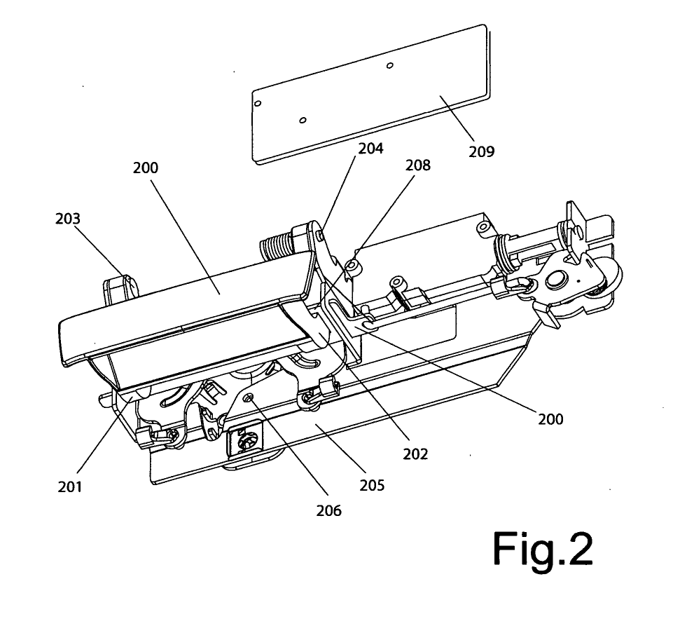

Referring to FIG. 2, the typical tailgate latching handle comprises a handle 200 hinging on arms 201 and 202 about pivots 203 and 204 on a handle bracket 205. The power lock described above is mounted to the handle bracket 205 by a fastener through the mounting hole 206 in such a fashion, that the hooks 207 and 208 of the locking bolt 100 hook over the arms 201 and 202 when the locking bolt 100 is in the extended position. A cover plate 209 mounts on top of the actuator 115 to shield the mechanism from tampering from the outside.

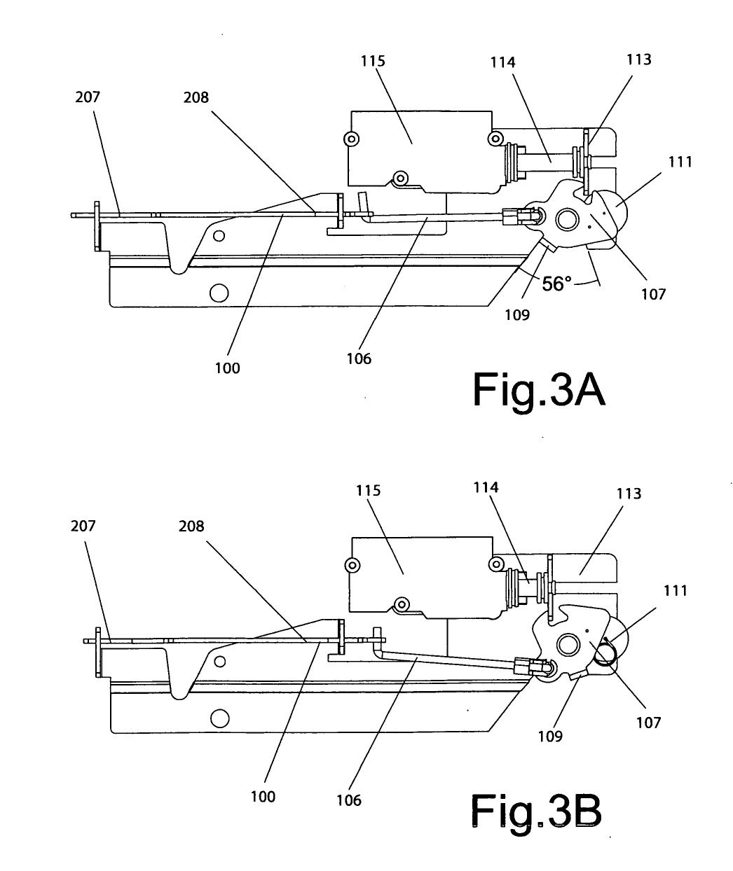

FIG. 3A is a plan view of the preferred embodiment in the “locked” position to illustrate its operation. When powered by an electrical pulse, the actuator 115 extends the output rod 114 and the driver 113 which turns the crank 107 clockwise until the pawl 109 stops at one end of the sector 110 shown to have 56 degrees travel. The rotation of the crank 107 is transferred to linear motion of the locking bolt 100 by the connecting rod 106. Note that the sector 110 is sized in such a fashion that the connecting rod 106 travels past dead center to a small angle such as 5 degrees before coming to a stop. Also note that spring 111 biases the linkage to rest against this stop.

As also shown in FIG. 2, the hooks 206 and 207 of the locking bolt 100 hook over the arms 201 and 202 of the handle 200 and lock its motion when the locking bolt 100 is in this extended position. Note that any attempt to push the locking bolt 100 back by outside means is foiled as the crank 107 is past dead center and any forcible push to unlock the handle 200 only drives the pawl 109 more firmly against the stop established by the sector 110. As a result, this mechanism is inherently tamperproof. A protective cover 208 cam be installed to further shield the mechanism against any tempering.

FIG. 3B shows the preferred embodiment in the “unlocked” position. When powered by an electrical pulse of the opposite polarity, the power actuator 115 retracts the output rod 114 as well as the driver 113 which turns the crank 107 clockwise until the pawl 109 stops at the other end of the sector. The connecting rod 106 retracts and slides the locking bolt 100 into the “unlock” position.

While this invention has been particularly shown and described with references to example embodiments thereof, it will be understood by those skilled in the art that various changes in form and details may be made therein without departing from the scope of the invention encompassed in the appended claim.

Thus, for instance, the spring loading or friction applied between the crank 107 and the bracket 105 can be applied instead between the locking bolt 100 and the bracket 105.

1. A power lock for a tailgate latching handle comprising:
(a) an electrically powered reciprocal linear actuator whose output rod is attached to a rack driver whose linear motion is transferred to the rotation of a crank
(b) a connecting rod that converts the crank rotation into sliding motion of a locking bolt
wherein the connecting rod travels past dead center when the actuator is fully extended.

2. The power lock of claim 1 wherein the rotation of the crank is limited by a stop past the dead center position of the connecting rod.

3. The power lock of claim 1. wherein the locking bolt has one or more hooks that lock the handle when the reciprocal linear actuator is energized.

4. The power lock of claim 1. wherein the crank or the locking bolt are spring loaded in the “locked” or “unlocked” positions.

5. The power lock of claim 1. wherein the crank or the locking bolt are retained in the “locked” or “unlocked” positions by friction.

6. The power lock of claim 1. wherein the electrically powered reciprocal linear actuator is coupled to the locking bolt with sufficient lost motion to allow it to return to its neutral position while the locking bolt remains locked or unlocked.
